(19) United States
(12) Patent Application Publication
(10) Pub. No.: US 2013/0200715 A1
(43) Pub. Date: Aug. 8, 2013

(54) CONVERTER ASSEMBLY AND A POWER PLANT INCLUDING THE CONVERTER ASSEMBLY

(71) Applicant: ABB RESEARCH LTD, Zurich (CH)

(72) Inventors: Sami PETTERSSON, Wettingen (CH); Ngai-Man Ho, Fislisbach (CH); Gerardo Escobar, Merida (MX)

(73) Assignee: ABB RESEARCH LTD, Zurich (CH)

(21) Appl. No.: 13/753,778

(22) Filed: Jan. 30, 2013

(30) Foreign Application Priority Data
Feb. 3, 2012 (EP) 12153799.7

(51) Int. Cl. H02M 7/537

(52) U.S. Cl. CPC H02M 7/537
USPC 307/82; 363/131

(57) ABSTRACT

A converter assembly includes a DC-DC converter, an inverter, a DC link, an input capacitor, an inductor and a neutral conductor. The DC-DC converter includes at least one DC-DC converter unit. The input capacitor includes an input capacitor unit for each of the at least one DC-DC converter unit, where each of the input capacitor units has a midpoint. The neutral conductor is connected to a neutral point on an output side of the inverter. The inductor includes an inverter side inductor between each output terminal of the inverter means and the neutral point on output side of the inverter. The neutral conductor is connected to the midpoint of each of the input capacitor units.

### RELATED APPLICATION

This application claims priority under 35 U.S.C. §119 to European Patent Application No. 12153799.7 filed in Europe on Feb. 3, 2012, the entire content of which is hereby incorporated by reference in its entirety.

### FIELD

The present disclosure relates to a converter assembly, and more particularly to avoiding ground leakage currents in the converter assembly.

### BACKGROUND INFORMATION

High-frequency common mode voltages are the main source of ground leakage currents. Problems caused by ground leakage currents are well known in the art.

### SUMMARY

An exemplary embodiment of the present disclosure provides a converter assembly which includes DC-DC converter means including at least one DC-DC converter unit having input terminals and an output. The exemplary converter assembly also includes inverter means having at least one input terminal and at least one output terminal. In addition, the exemplary converter assembly includes a DC link electrically connecting the output of the at least one DC-DC converter unit to the at least one input terminal of the inverter means. Furthermore, the exemplary converter assembly includes input capacitor means including an input capacitor unit for a corresponding one of each of the at least one DC-DC converter unit, each input capacitor unit being connected between the input terminals of a corresponding one of the at least one DC-DC converter unit. The exemplary converter assembly also includes a neutral conductor connected to a neutral point on an output side of the inverter means. In addition, the exemplary converter assembly includes inductor means including an inverter side inductor between each output terminal of the inverter means and the neutral point on the output side of the inverter means. The neutral conductor is connected to a corresponding midpoint of each of the input capacitor units.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a power plant including a converter assembly according to an exemplary embodiment of the present disclosure;

FIG. 2 shows a power plant including a converter assembly according to an exemplary embodiment of the present disclosure; and

FIG. 3 shows more closely the structure of DC-DC converter means and inverter means of the power plant of FIG. 2.

### DETAILED DESCRIPTION

Exemplary embodiments of the present disclosure provide a converter assembly which can effectively attenuate high-frequency common mode currents, and a power plant utilizing the converter assembly. In accordance with an exemplary embodiment, the converter assembly includes DC-DC converter means including at least one DC-DC converter unit having an output. The exemplary converter assembly also includes inverter means having at least one input terminal and at least one output terminal. In addition, the exemplary converter assembly includes a DC link electrically connecting the output of the at least one DC-DC converter unit to the at least one input of the inverter means. Furthermore, the exemplary converter assembly includes input capacitor means including an input capacitor unit for a corresponding one of each of the at least one DC-DC converter unit, where each input capacitor unit is connected between the input of a corresponding one of the at least one DC-DC converter unit and having a midpoint. The exemplary converter assembly also includes a neutral conductor connected to a neutral point on an output side of the inverter means. In addition, the exemplary converter assembly includes inductor means including an inverter side inductor between each output terminal of the inverter means and the neutral point on the output side of the inverter means. The neutral conductor is connected to the midpoint of each of the input capacitor units.

Additional features of the present disclosure will be described with reference to exemplary embodiments illustrated in the drawings.

Exemplary embodiments of the present disclosure are based on the concept of connecting the neutral conductor to the midpoint of each of the input capacitor units while the neutral conductor is galvanically separated from the input midpoint of at least one DC-DC converter unit. Thus, the common mode current filtering is combined into one circuit, which means that the common mode current circulates through the whole system.

An advantage of the converter assembly of the present disclosure is that the inverter side inductors located between output terminals of the inverter means and the neutral point on an output side of the inverter means also contribute to the filtering of the common mode current generated by the DC-DC converter means. In addition, shutdown or bypassing of DC-DC converter unit(s) of the DC-DC converter means does not affect the attenuation of high-frequency common mode currents.

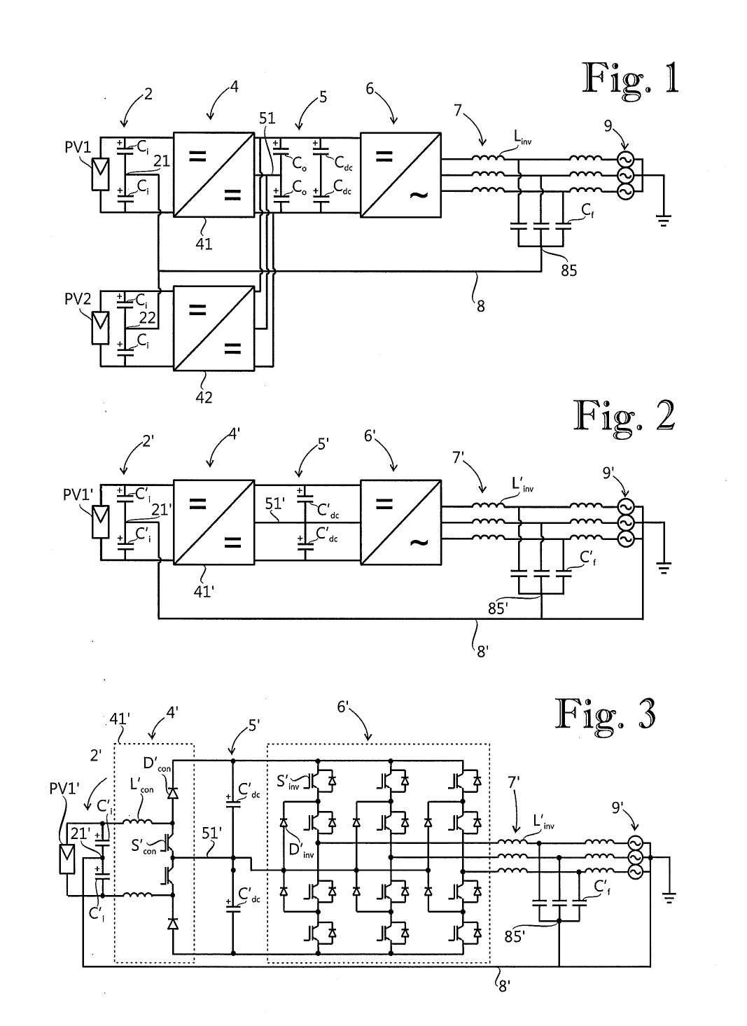

FIG. 1 shows a power plant including power supply means for generating DC current and a converter assembly according to an exemplary embodiment of the present disclosure.

The converter assembly of FIG. 1 is a transformerless converter assembly, or a non-isolated converter assembly. The converter assembly includes DC-DC converter means 4, inverter means 6, a DC link 5, input capacitor means 2, inductor means 7, and a neutral conductor 8.

The DC-DC converter means 4 include parallel connected DC-DC converter units 41 and 42. Both the DC-DC converter unit 41 and the DC-DC converter unit 42 have a symmetrical structure in respect of a midpoint thereof.

The DC link 5 connects electrical outputs of the DC-DC converter units 41 and 42 to an input of the inverter means 6. The input capacitor means 2 include an input capacitor unit for each of the DC-DC converter units 41 and 42, respectively. Each of the input capacitor units is connected between input terminals of a corresponding one of the DC-DC converter unit 41, 42 and has a midpoint. A midpoint of the input capacitor unit corresponding to the DC-DC converter unit 41 is denoted with reference numeral 21, and a midpoint of the input capacitor unit corresponding to the DC-DC converter unit 42 is denoted with reference numeral 22.

A capacitance between a midpoint of an input capacitor unit and a positive input terminal of corresponding DC-DC converter unit is substantially equal to a capacitance between the midpoint of the input capacitor unit and a negative input terminal of the corresponding DC-DC converter unit. For example, a capacitance Cᵢ between the midpoint 21 and a positive input terminal of DC-DC converter unit 41 is equal to a capacitance Cᵢ between the midpoint 21 and a negative input terminal of DC-DC converter unit 41.

The neutral conductor 8 is connected to a neutral point 85 on an output side of the inverter means 6 and to the midpoint of each of the input capacitor units. There is a neutral point filter capacitor C_{f} between each output terminal of the inverter means 6 and the neutral point 85 on the output side of the inverter means 6.

The inductor means 7 include an inverter side inductor Lᵢₙᵥ between each output terminal of the inverter means 6 and the neutral point 85 on the output side of the inverter means 6. Each of the inverter side inductors Lᵢₙᵥ is connected in series with a load of the inverter means 6. The load includes a grid 9.

The DC link 5 includes a filter capacitor unit and an energy storage unit. The filter capacitor unit includes two filter capacitors Cₒ connected in series between a positive bus bar of the DC link 5 and a negative bus bar of the DC link 5. A midpoint of the filter capacitor unit is connected to an output midpoint of each of the DC-DC converter units 41 and 42 with a midpoint conductor 51. The energy storage unit includes two energy storage capacitors C_{dc} connected in series between a positive bus bar of the DC link 5 and a negative bus bar of the DC link 5.

Each of the DC-DC converter units 41 and 42 is configured to step up direct voltage (DC). In accordance with an exemplary embodiment, the DC-DC converter units 41 and 42 can include boost converters. In accordance with an exemplary embodiment, the DC-DC converter units are also configured to step down direct voltage.

A modulation sequence of the inverter means 6 is synchronized with a modulation sequence of each of the DC-DC converter units 41 and 42. Due to the synchronization, the modulation period starts and ends at the same time for the inverter means 6 and DC-DC converter units 41 and 42. The synchronization results in a natural current ripple cancellation in the neutral conductor 8.

The power supply means include a power supply unit for each DC-DC converter unit 41, 42. Each power supply unit has supply terminals and is configured to generate a direct current and to feed the direct current out of the power supply unit via the supply terminals. The supply terminals of each power supply unit are connected to input terminals of a corresponding DC-DC converter unit.

In accordance with an exemplary embodiment, the power plant of FIG. 1 may be a solar power plant. Each power supply unit includes a photovoltaic cell unit configured to convert solar energy into direct current. Supply terminals of photovoltaic cell unit PV1 are connected to input terminals of the DC-DC converter unit 41. Supply terminals of photovoltaic cell unit PV2 are connected to input terminals of the DC-DC converter unit 42.

FIG. 2 shows a power plant including a converter assembly according to another exemplary embodiment of the present disclosure. The converter assembly illustrated in FIG. 2 includes DC-DC converter means 4′, inverter means 6′, a DC link 5′, input capacitor means 2′, inductor means 7′, and a neutral conductor 8′. The DC-DC converter means 4′ include a DC-DC converter unit 41′ having a symmetrical structure in respect of a midpoint thereof.

The main difference between the power plant of FIG. 2 and the power plant of FIG. 1 is that the power plant of FIG. 2 includes only one photovoltaic cell unit, denoted as PV1′, and only one DC-DC converter unit 41′. Also, a neutral point 85′ on the output side of inverter means 6′ is grounded in FIG. 2, while the neutral point 85 on output side of the inverter means 6 in FIG. 1 includes only so-called virtual ground without a galvanic connection to the grid, where the virtual ground enables a better utilization of the DC link voltage. Additional differences can be found in the DC link 5′.

The DC link 5′ connects an electrical output of the DC-DC converter unit 41′ to an input of the inverter means 6′. The DC link 5′ includes an energy storage unit but no separate filter capacitor unit. The energy storage unit includes two energy storage capacitors C′_{dc} connected in series between a positive bus bar of the DC link 5′ and a negative bus bar of the DC link 5′. A midpoint conductor 51′ connects an output midpoint of the DC-DC converter unit 41′ with a midpoint of the energy storage unit and an input midpoint of the inverter means 6′.

The DC-DC converter means 4′ includes a three-level boost converter, which is also known as a mirrored or symmetric boost converter. The inverter means 6′ include a three-phase three-level neutral point clamped inverter bridge. FIG. 3 shows more closely the structure of the boost converter and the inverter bridge. The DC-DC converter means 4′ includes two converter inductors L′_{con}, two converter switches S′_{con}, and two converter diodes D′_{con}. The inverter means 6′ include, for example, twelve inverter switches S′ᵢₙᵥ and six inverter diodes D′ᵢₙᵥ.

The converter assembly according to the present disclosure is not limited to a boost converter and a three-level inverter. In alternative embodiments, DC-DC converter means can include a different type of converter, such as a buck-boost converter, and the inverter means can include a two-level inverter or a five-level inverter, for example.

Further, the number of phases of the inverter means is not limited to three. In alternative embodiments, the inverter means can include a single-phase or a two-phase inverter. In an exemplary embodiment with a single-phase or two-phase inverter, the inverter means have only two output terminals. There is a neutral point filter capacitor between each output terminal of the inverter means and the neutral point on output side of the inverter means.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. A converter assembly comprising:
DC-DC converter means including at least one DC-DC converter unit having input terminals and an output;
inverter means having at least one input terminal and at least one output terminal;
a DC link electrically connecting the output of the at least one DC-DC converter unit to the at least one input terminal of the inverter means;
input capacitor means including an input capacitor unit for a corresponding one of each of the at least one DC-DC converter unit, each input capacitor unit being connected between the input terminals of a corresponding one of the at least one DC-DC converter unit;
a neutral conductor connected to a neutral point on an output side of the inverter means; and
inductor means including an inverter side inductor between each output terminal of the inverter means and the neutral point on the output side of the inverter means,
wherein the neutral conductor is connected to a corresponding midpoint of each of the input capacitor units.

2. A converter assembly according to claim 1, wherein each inverter side inductor is connected in series with a load of the inverter means.

3. A converter assembly according to claim 1, comprising:
a neutral point filter capacitor between each output terminal of the inverter means and the neutral point on the output side of the inverter means.

4. A converter assembly according to claim 1, wherein each of the at least one DC-DC converter unit of the DC-DC converter means has a symmetrical structure with respect to a midpoint of the at least one DC-DC converter unit.

5. A converter assembly according to claim 1, wherein a modulation sequence of the inverter means is synchronized with a modulation sequence of each of the at least one DC-DC converter unit.

6. A converter assembly according to claim 1, wherein the at least one DC-DC converter unit is configured to step up direct voltage.

7. A converter assembly according to claim 6, wherein the at least one DC-DC converter unit is configured to step down direct voltage.

8. A power plant comprising:
power supply means including at least one power supply unit having supply terminals, each of the power supply units being configured to generate a direct current and to feed the direct current out of the power supply unit via the supply terminals; and
a converter assembly according to claim 1,
wherein the supply terminals of each power supply unit are connected to input terminals of corresponding one of the at least one DC-DC converter unit.

9. A power plant according to claim 8, wherein:
the power plant is a solar power plant; and
each power supply unit includes a photovoltaic cell unit configured to convert solar energy into direct current.

10. A power plant comprising:
power supply means including at least one power supply unit having supply terminals, each of the power supply units being configured to generate a direct current and to feed the direct current out of the power supply unit via the supply terminals; and
a converter assembly according to claim 2,
wherein the supply terminals of each power supply unit are connected to input terminals of corresponding one of the at least one DC-DC converter unit.

11. A power plant according to claim 10, wherein:
the power plant is a solar power plant; and
each power supply unit includes a photovoltaic cell unit configured to convert solar energy into direct current.

12. A power plant comprising:
power supply means including at least one power supply unit having supply terminals, each of the power supply units being configured to generate a direct current and to feed the direct current out of the power supply unit via the supply terminals; and
a converter assembly according to claim 3,
wherein the supply terminals of each power supply unit are connected to input terminals of corresponding one of the at least one DC-DC converter unit.

13. A power plant according to claim 12, wherein:
the power plant is a solar power plant; and
each power supply unit includes a photovoltaic cell unit configured to convert solar energy into direct current.

14. A power plant comprising:
power supply means including at least one power supply unit having supply terminals, each of the power supply units being configured to generate a direct current and to feed the direct current out of the power supply unit via the supply terminals; and
a converter assembly according to claim 4,
wherein the supply terminals of each power supply unit are connected to input terminals of corresponding one of the at least one DC-DC converter unit.

15. A power plant according to claim 14, wherein:
the power plant is a solar power plant; and
each power supply unit includes a photovoltaic cell unit configured to convert solar energy into direct current.

16. A power plant comprising:
power supply means including at least one power supply unit having supply terminals, each of the power supply units being configured to generate a direct current and to feed the direct current out of the power supply unit via the supply terminals; and
a converter assembly according to claim 5,
wherein the supply terminals of each power supply unit are connected to input terminals of corresponding one of the at least one DC-DC converter unit.

17. A power plant according to claim 16, wherein:
the power plant is a solar power plant; and
each power supply unit includes a photovoltaic cell unit configured to convert solar energy into direct current.

18. A power plant comprising:
power supply means including at least one power supply unit having supply terminals, each of the power supply units being configured to generate a direct current and to feed the direct current out of the power supply unit via the supply terminals; and
a converter assembly according to claim 7,
wherein the supply terminals of each power supply unit are connected to input terminals of corresponding one of the at least one DC-DC converter unit.

19. A power plant according to claim 18, wherein:
the power plant is a solar power plant; and
each power supply unit includes a photovoltaic cell unit configured to convert solar energy into direct current.
